(19) United States
(12) Patent Application Publication
(10) Pub. No.: US 2016/0321569 A1
(43) Pub. Date: Nov. 3, 2016

(54) TELEPHONE INFRASTRUCTURE ENHANCEMENT

(71) Applicant: Thing5, LLC, Springfield, MA (US)

(72) Inventor: John Carey, West Hartford, CT (US)

(21) Appl. No.: 15/141,159

(22) Filed: Apr. 28, 2016

Related U.S. Application Data
(60) Provisional application No. 62/153,837, filed on Apr. 28, 2015.

(51) Int. Cl. G06Q 10/02; H04W 4/02; G06Q 50/12; H04L 29/06

(52) U.S. Cl. CPC G06Q 10/02; H04L 65/1053; H04W 4/02; G06Q 50/12

(57) ABSTRACT

Aspects of the disclosure are directed to a system associated with at least one hotel, comprising a communications infrastructure, and at least one property management computer, where the at least one property management computer is configured to store data related to a guest reservation, the data including an identifier associated with a user device associated with the guest, and where the at least one property management computer is configured to enable the user device to utilize the communications infrastructure based on the identifier. From the perspective of a user/guest of the hotel, the user may use a UD to access one or more services or to engage in one or more communications while at the hotel. Accordingly, the user might not be tethered to a dedicated telephone at the hotel.

### PRIORITY INFORMATION

This application claims priority to U.S. provisional application Ser. No. 62/153,837 filed Apr. 28, 2015, which is hereby incorporated by reference.

### BACKGROUND

Telephone infrastructure/platforms located in, e.g., hotels/motels frequently utilize a private branch exchange (PBX) network to facilitate telecommunications. Users (e.g., guests of the hotel) of the PBX share a number of outside lines for making external telephone calls from their rooms. The PBX connects the internal telephones within the hotel and also connects them to a public switched telephone network (PSTN), Voice over Internet Protocol (VoIP) providers, and Session Initiation Protocol (SIP) trunks.

Conventional telephone technology in the hotel relates/maps a user to her room based on the use of a dedicated telephone located in the room. For example, while the user is staying at the hotel the user may access services provided by the hotel (e.g., room service—food delivery, booking spa treatments, ordering a car from valet parking, concierge services, et cetera) based on placing a phone call from that dedicated telephone. The use of the dedicated telephone places limits on the features that may be available to the user or to the hotel, resulting in a less-than-optimal utilization of the telephone infrastructure.

What is needed is a system that allows a hotel guest to access hotel guest room phone functionality independent of the wireline hotel guest room.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a system associated with at least one hotel, comprising a communications infrastructure, and at least one property management computer, where the at least one property management computer is configured to store data related to a guest reservation, the data including an identifier associated with a user device associated with the guest, and where the at least one property management computer is configured to enable the user device to utilize the communications infrastructure based on the identifier. In some embodiments, the user device includes at least one of a cell phone or a smartphone. In some embodiments, the identifier includes a telephone number associated with the at least one of a cellular phone or a smartphone. In some embodiments, the communications infrastructure includes a private branch exchange network. In some embodiments, the at least one property management computer is configured to enable the user device to communicate using the communications infrastructure based on the identifier. In some embodiments, the at least one property management computer is configured to enable the user device to communicate via a voice call using the communications infrastructure based on the identifier. In some embodiments, the at least one property management computer is configured to enable the user device to communicate via data using the communications infrastructure based on the identifier. In some embodiments, the data includes text. In some embodiments, the system further comprises at least one radio transceiver configured to communicate with the user device. In some embodiments, the system comprises the user device. In some embodiments, the user device includes at least one application that enables the user device to utilize the communications infrastructure.

Aspects of the disclosure are directed to a method comprising receiving, by at least one computer, a reservation associated with a guest of a hotel, receiving, by the at least one computer, an indication that a user device associated with the guest is to be integrated with a communications infrastructure associated with the hotel, and at least temporarily integrating the user device with the communications infrastructure based on the indication. In some embodiments, the communications infrastructure includes a telephone communications infrastructure. In some embodiments, the telephone communications infrastructure includes a private branch exchange network. In some embodiments, the method further comprises integrating the user device with the communications infrastructure for a duration of a stay of the guest at the hotel that is based on the reservation. In some embodiments, the user device includes a smartphone. In some embodiments, the method further comprises associating, by the at least one computer, the user device to a guest room of the hotel. In some embodiments, the integration of the user device with the communications infrastructure enables at least one of a voice call or a transfer of data with respect to the user device. In some embodiments, the method further comprises checking-in the guest to the hotel based on the user device being located within a communication range of the hotel. In some embodiments, the checking-in of the guest to the hotel is based on the user device being located within a Wi-Fi communication range of the hotel at a time coinciding with a check-in time associated with the reservation.

### BRIEF DESCRIPTION OF THE DRAWINGS

The present disclosure is illustrated by way of example and not limited in the accompanying figures in which like reference numerals indicate similar elements.

FIGS. 1A-1B are block diagrams of systems for providing communication services in accordance with aspects of the disclosure.

FIG. 2 is a flow chart of an exemplary method for integrating a user device into the telephone infrastructure of a hotel.

### DETAILED DESCRIPTION

It is noted that various connections are set forth between elements in the following description and in the drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

In accordance with various aspects of the disclosure, apparatuses, systems and methods are described for integrating functionality with respect to a communications system, such as a telephone platform/infrastructure. In some embodiments, the integration of the functionality may be based on the use of one or more user devices.

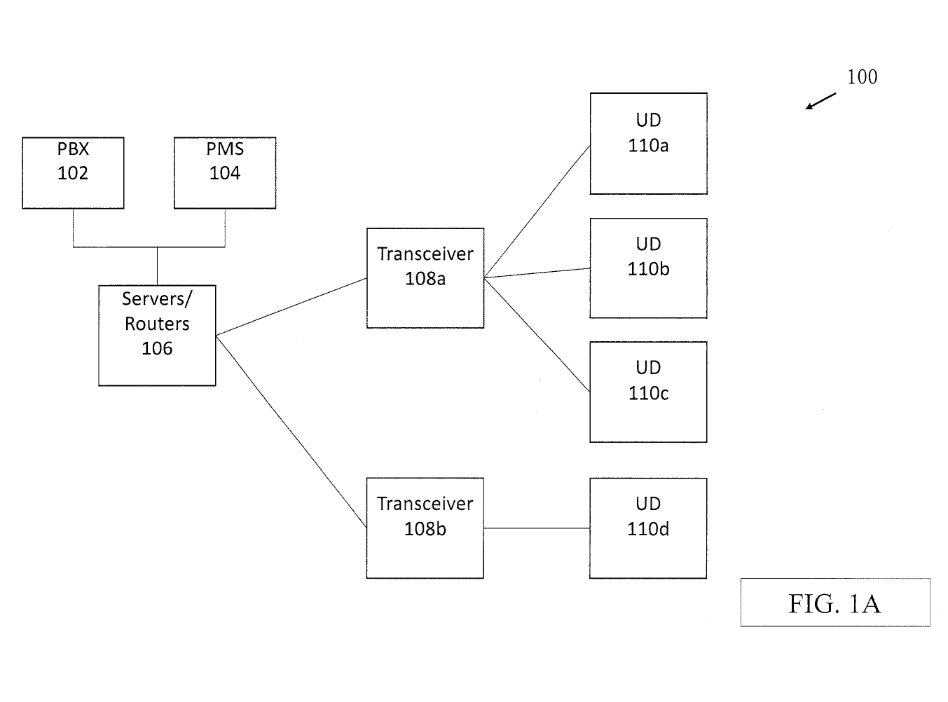

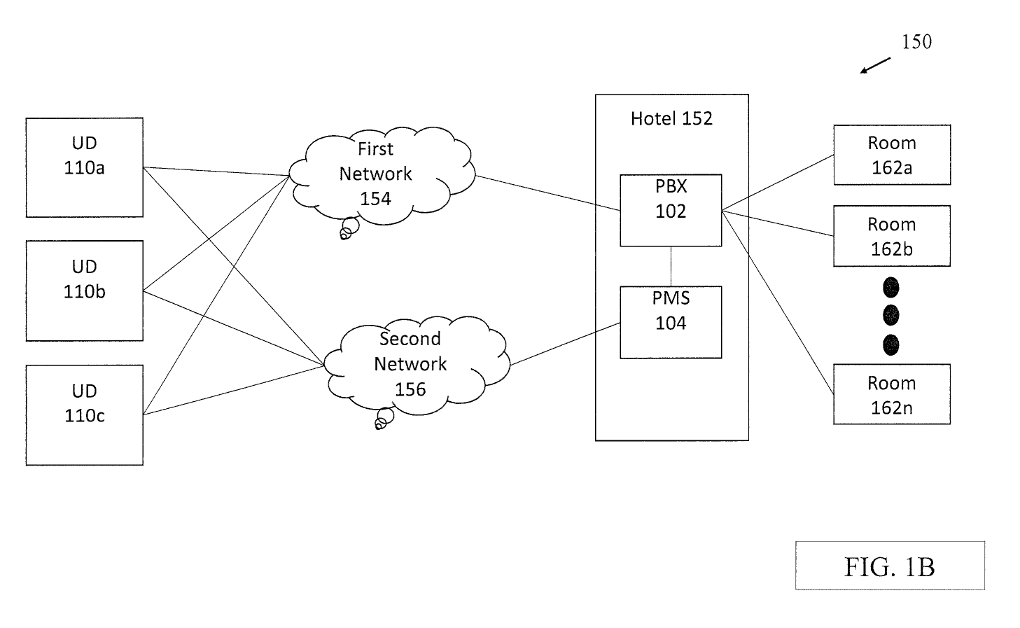

Referring to FIG. 1A, a communication system 100 in accordance with aspects of the disclosure is shown in block diagram form. For purposes of illustration, the system 100 is described below in the context of its use in a hotel (or one or more hotels, potentially as part of a chain of hotels). One skilled in the art would appreciate that aspects of the system 100 may be implemented in connection with other applications or environments, such as for example in association with one or more office buildings, stadiums, etc.

The system 100 may include a private branch exchange (PBX) 102. The types of components/devices that may be utilized in connection with a PBX 102 would be known to one of skill in the art, and so, a further description of the PBX 102 is omitted herein for the sake of brevity.

The system 100 may include a property management system (PMS) 104. The PMS 104 may be responsible for integrating and managing data associated with the hotel(s). For example, the PMS 104 may store data related to user/guest reservations, laundry services, room service (e.g., food orders/deliveries), pay-per-view (PPV) programming and associated orders from guests, accounts payable/receivable, etc. In some embodiments, the PMS 104 may store data related to one or more user devices (UDs) as is described further below. The PMS 104 may include one or more computers (e.g., one or more servers). It is contemplated that the PMS may be located for example in the cloud, or located on-site at the hotel premises as shown in FIG. 1A.

The PBX 102 and the PMS 104 may be coupled to one or more servers, routers, etc., generally denoted in FIG. 1A by reference character 106. The PMS 104 may issue one or more commands to the server 106 that direct the server 106 to convey/transmit status or content/data.

The server 106 may be coupled to one or more transceivers, such as transceivers 108a and 108b. The transceivers 108a and 108b may be operative in accordance with wired communications. The transceivers 108a and 108b may be operative in accordance with wireless communications.

In the system 100 depicted in FIG. 1A, the transceiver 108a is shown as being coupled to user devices (UDs) 110a, 110b, and 110c. Similarly, the transceiver 108b is shown as being coupled to UD 110d. The coupling of a given UD (e.g., UD 110a) to a given transceiver (e.g., transceiver 110a) may be based on one or more factors or conditions. For example, the coupling may be based on a location of the transceiver or the UD, loads experienced by the transceivers or the system 100, tiers or priority of services (e.g., users may pay the hotel a fee to obtain faster access times with respect to one or more services, where faster service may be obtained over one communication link/transceiver), a user's actual or scheduled/tentative attendance at a given event (e.g., a conference sponsored by, or located at, the hotel), etc.

The UDs 110a-110d may be of any type. Some illustrative examples of UDs include personal computers (PCs), laptop computers, mobile devices (e.g., cell phones or smartphones), etc.

The integration of the UDs 110a-110d into the system 100 may allow the UDs to supplement, or even replace, the use of a dedicated telephone by a user in the hotel. For example, for the duration of a user's stay at the hotel, services provided by (or associated with) the hotel may be supported by a UD.

The use of a UD may enable voice capabilities. For example, a user may engage in a phone call using her UD while hooking into or integrating with the PBX 102. Such a phone call may be confined to the hotel itself (e.g., from the user's room to a second user's room) or may bridge/span the hotel to enable the user to speak with a second user that is not associated with the hotel.

The use of a UD may enable data capabilities. Such data capabilities may include the transmission or reception of text (e.g., text messages, emails, etc.), content (e.g., graphics, pictures, movies, radio programs, etc.), etc.

The system 100 may operatively be associated with one or more communication protocols, standards, etc. In some embodiments, communication in the system 100 may be facilitated via one or more networks. In some embodiments, the system 100 may be operative on the basis of a cloud computing architecture.

Referring now to FIG. 1B, a system 150 is shown. The system 150 includes many of the components and devices described above in connection with the system 100 of FIG. 1A, and so, a complete re-description is omitted for the sake of brevity.

The system 150 may include one or more UDs, such as for example UDs 110a-110c. The UDs may be communicatively coupled to a hotel 152 (which may include the PBX 102 and/or the PMS 104) via a first network 154 and/or a second network 156. In some embodiments, the first network 154 may be coupled to the hotel PBX 102. In some embodiments, the second network 156 may be coupled to the PMS 104.

In some embodiments, the first network 154 may include a cellular network. In some embodiments, the first network 154 may include a public switched telephone network (PSTN).

In some embodiments, the second network 156 may include the Internet or an associated Internet/Intranet backbone/infrastructure.

As shown in FIG. 1B, the PBX 102 may be coupled to one or more rooms, illustratively denoted as room 162a, 162b, . . . 162n. The architecture of the system 150 may be used to map a given UD (e.g., UD 110a) to a given room (e.g., room 162a).

While shown separately, aspects of the system 100 may be combined with aspects of the system 150 in some embodiments.

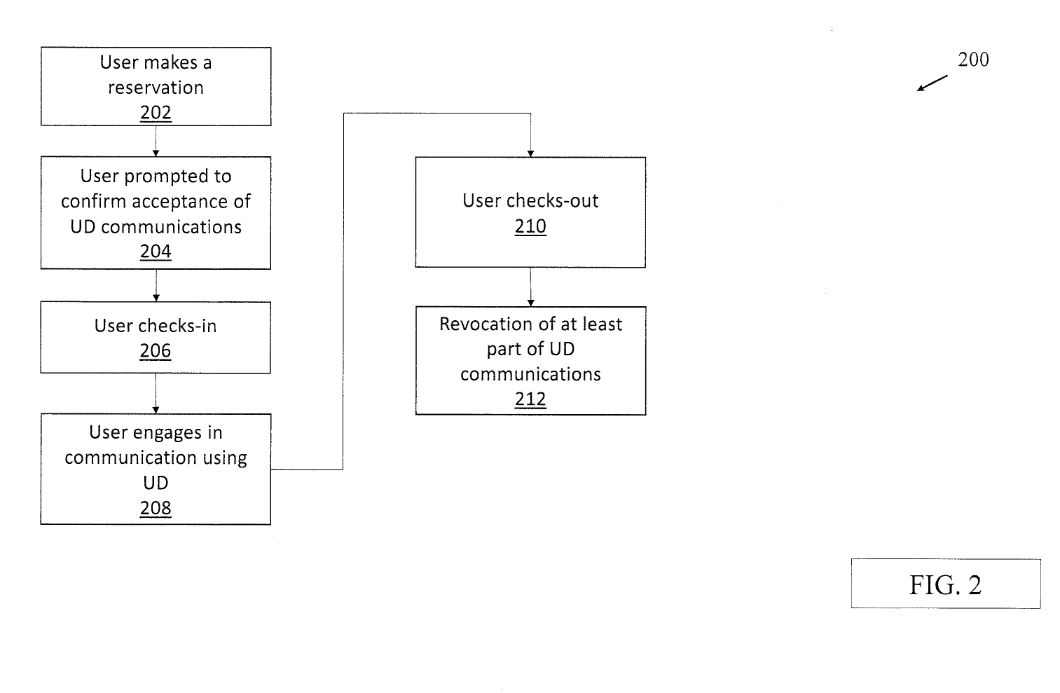

Having just described the architecture of the systems 100 and 150, an illustrative use-case/scenario involving the system 100 and/or the system 150 is described below with reference to the method 200 of FIG. 2.

In block 202, a user may make a reservation at the hotel (e.g., hotel 152). The reservation may be made in advance of the user's stay at the hotel, or may be made at the start of the user's stay at the hotel. The reservation may include a specification of one or more identifiers associated with the user, such as for example the user's name, residential address, anticipated date of check-in or check-out, whether the user will be parking a vehicle on the premises, whether the user will be bringing any luggage, etc. As part of block 202, the hotel may select/allocate one or more resources (e.g., hotel rooms, conference rooms, spa facilities, etc.) to the user.

In block 204, the user may be prompted/requested to confirm that the user would like to accept (e.g., transmit or receive) communications to/from the hotel communication infrastructure using a UD. If the user would like to accept such communications, an identifier associated with the UD (e.g., a telephone number of the UD if the UD includes, e.g., a smartphone) may be provided by the user or the UD to, e.g., the PMS 104 or the servers 106. The PMS 104/servers 106 may then map/relate the UD to the reservation of block 202.

In block 206, the user may check-in to the hotel. The check-in may adhere to a traditional/conventional check-in procedure where the user gives her name, reservation number, etc. to, e.g., a parking attendant or a clerk located at a reception desk of the hotel.

The check-in of block 206 may be based on the UD of the user being located within a range of communication (e.g., a Wi-Fi communication range) provided by the hotel or the system 100. Such features may enable staff (e.g., parking attendants, bell-hops, etc.) to be prepared to greet the user upon the user's arrival.

In block 208, the user may engage in one or more communications (e.g., voice or data communications) using the UD. The communications may be facilitated by the UD hooking into, or integrating with, one or more of the PBX 102, the PMS 104, or the server 106, potentially via one or more networks (e.g., network 154, 156).

The communications of block 208 may pertain to one or more services provided/sponsored by the hotel, or even a third party service. For example, the user may place an order for room service using the UD, and the mapping of the UD to the reservation 202 provided in block 204 may enable the hotel's personnel to deliver food to the user's room. Similarly, if the user requests a wake-up call the wake-up call may be received by the user's UD. Advertisements that may be of potential interest to the user may be pushed to the UD (or pulled by the UD upon the user's/UD's request).

The communications of block 208 may be subject to one or more encryption schemes/techniques. Such encryption may be used to mitigate against the likelihood that information associated with the user or the hotel may be compromised.

In block 210, the user may check-out. Similar to the check-in of block 206, the check-out of block 210 may be based on the user interacting with one or more members of the hotel personnel/staff and/or may be based on the UD of the user no longer being located within a communication range of the system 100.

In block 212, at least part of the UD's ability to communicate with the hotel's communication infrastructure (e.g., telephone infrastructure) may be revoked subsequent to the check-out of block 210. For example, following check-out in block 210 the user/UD may be prevented from placing a phone call to room service in order to prevent the user from ordering food to be delivered to the room that she was previously staying in (and perhaps already occupied by another user/guest). However, other features or capabilities may be retained following check-out, such as for example the user or the UD's ability to place a dinner reservation with a restaurant located in the hotel. In this respect, the integration of the UD with respect to the hotel's communications infrastructure may be temporary.

The choice of which features/capabilities or communications to enable or disable, and the timing associated therewith, may be based on criteria/policies specified by the user and/or the hotel management (or any of the devices associated with the user or the hotel).

The method 200 is illustrative. In some embodiments, the blocks may execute in an order or sequence that is different from what is shown. In some embodiments, one or more of the blocks (or one or more portions thereof) may be optional. In some embodiments, additional blocks not shown may be included.

In accordance with aspects of the disclosure, opportunities are provided for enhancing experiences associated with one's stay at a hotel. From the perspective of a user/guest of the hotel, the user may use a UD to access one or more services or to engage in one or more communications while at the hotel. Accordingly, the user might not be tethered to a dedicated telephone at the hotel. From the perspective of the hotel (or associated hotel management), statistics may be compiled regarding services requested by users, dates/times when users access such services, etc. Such statistics may be analyzed to provide for an optimal allocation/staffing of such services, to provide a customized user experience, etc.

In accordance with aspects of the disclosure, a user may be able to communicate with one or more departments/groups associated with the hotel using a UD. Such departments may include, or be associated with, a front/reception desk, concierge, directory, voicemails, wake up call, messages, etc. Access to the departments/groups may be facilitated/supported by one or more applications which may be included in a UD.

In some embodiments, one or more function/procedure calls may be executed by a UD and/or hotel communication infrastructure to support one or more functions/capabilities/features. Table 1 below provides a listing of such functions and a description associated with each function.

TABLE 1
FUNCTIONS AND ASSOCIATED DESCRIPTIONS

| Function | Description |
|---|---|
| POST/call | Saves a call to an external DID or hotel |
| | extension |
| DELETE/site/[a-zA-Z0-9]+ | Remove a directory listing for a property |
| GET/site/[a-zA-Z0-9]+ | Retrieve a directory listing |
| POST/site/[a-zA-Z0-9]+ | Save a directory listing |
| DELETE/pair | Disables a call forwarding from a room |
| | number |
| GET/paired/[a-zA-Z0-9]+ | Retrieve a list of paired users |
| POST/pair | Sets up room calls to go to an external |
| | number |
| GET/messages/[0-9]{10}* | Check for messages; parameters are URI |
| @uri/messages/pm | based. Messages may expire after a given |
| | timeframe (e.g., 24 hours) |
| POST/messages | Send a message. The recipients may need to |
| | be currently paired (see GET/paired above) |
| POST/messages/read/0-9a-zA-Z]{24} | Mark a message read; parameters are URI |
| | based. |
| GET/events/s/[0-9]{4}-[0-9]{2}-[0- | Returns a selection of events as specified by |
| 9]{2}/e[0-9]{4}-[0-9]{2}-[0-9]{2}/type/[a- | a start and end date and optionally an event |
| zA-Z]+ | type. The parameters are URI based |
| DELETE/users | Delete a user by username. May be internal |
| | only. |
| GET/users | Retrieve a user listing. May be internal only. |
| POST/users | Save a new user, potentially in conjunction |
| | with a password. |
| GET/voicemail/property/[a-zA-Z0- | Returns the number of voicemails a guest |
| 9]+/room/[0-9]+ | currently has |

The functions or function calls listed in Table 1 are exemplary. One skilled in the art would appreciate that other formats for function calls may be used. Additional function calls not shown may be included.

Aspects of the disclosure may be used to enhance telephone infrastructure resident at a hotel. For example, the feature set that is available to users/guests at the hotel may be enhanced by enabling the users/guests to use UDs (potentially via one or more applications) in conjunction with exiting telephony of the hotel's information technology systems.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure.

What is claimed is:

1. A system associated with at least one hotel, comprising:
a communications infrastructure; and
at least one property management computer;
wherein the at least one property management computer is configured to store data related to a guest reservation, the data including an identifier associated with a user device associated with the guest, and
wherein the at least one property management computer is configured to enable the user device to utilize the communications infrastructure based on the identifier.

2. The system of claim 1, wherein the user device includes at least one of a cell phone or a smartphone.

3. The system of claim 2, wherein the identifier includes a telephone number associated with the at least one of a cell phone or a smartphone.

4. The system of claim 1, wherein the communications infrastructure includes a private branch exchange network.

5. The system of claim 1, wherein the at least one property management computer is configured to enable the user device to communicate using the communications infrastructure based on the identifier.

6. The system of claim 5, wherein the at least one property management computer is configured to enable the user device to communicate via a voice call using the communications infrastructure based on the identifier.

7. The system of claim 5, wherein the at least one property management computer is configured to enable the user device to communicate via data using the communications infrastructure based on the identifier.

8. The system of claim 7, wherein the data includes text.

9. The system of claim 1, further comprising at least one transceiver configured to communicate with the user device.

10. The system of claim 1, further comprising the user device.

11. The system of claim 10, wherein the user device includes at least one application that enables the user device to utilize the communications infrastructure.

12. A method comprising:
receiving, by at least one computer, a reservation associated with a guest of a hotel;
receiving, by the at least one computer, an indication that a user device associated with the guest is to be integrated with a communications infrastructure associated with the hotel; and
at least temporarily integrating the user device with the communications infrastructure based on the indication such that voice calls can be received by the user device from the communication infrastructure.

13. The method of claim 12, wherein the communications infrastructure includes a telephone communications infrastructure.

14. The method of claim 13, wherein the telephone communications infrastructure includes a private branch exchange network.

15. The method of claim 12, further comprising:
integrating the user device with the communications infrastructure for a duration of a stay of the guest at the hotel that is based on the reservation.

16. The method of claim 12, wherein the user device includes a smartphone.

17. The method of claim 12, further comprising:
associating, by the at least one computer, the user device to a guest room of the hotel.

18. The method of claim 12, wherein the integration of the user device with the communications infrastructure enables at least one of a voice call or a transfer of data with respect to the user device.

19. The method of claim 12, further comprising:
checking-in the guest to the hotel based on the user device being located within a communication range of the hotel.

20. The method of claim 19, wherein the checking-in of the guest to the hotel is based on the user device being located within a Wi-Fi communication range of the hotel at a time coinciding with a check-in time associated with the reservation.
